(19) United States
(12) Patent Application Publication
(10) Pub. No.: US 2012/0021141 A1
(43) Pub. Date: Jan. 26, 2012

(54) COMPOSITION FOR LIQUID CRYSTAL ALIGNMENT LAYER AND LIQUID CRYSTAL ALIGNMENT LAYER

(75) Inventors: Dong-Woo YOO, Yuseong-gu (KR); Sung-Ho CHUN, Seo-gu (KR); Dai-Seung CHOI, Yuseong-gu (KR); Young-Chul WON, Seo-gu (KR); Wan-Hee GOH, Seo-gu (KR)

(73) Assignee: LG CHEM, LTD., Seoul (KR)

(21) Appl. No.: 13/188,204

(22) Filed: Jul. 21, 2011

(30) Foreign Application Priority Data
Jul. 23, 2010 (KR) 10-2010-0071524

(51) Int. Cl. C09K 19/38; B05D 5/00; B05D 3/06; C09K 19/56

(52) U.S. Cl. 428/1.2; 252/299.4; 427/517

(57) ABSTRACT

The present invention relates to a composition for liquid crystal alignment layer used to provide a liquid crystal alignment layer that exhibits excellent alignment and maintains stable alignment without disturbance despite external stress such as electrical/thermal stress, a liquid crystal alignment layer, and a liquid crystal cell. The composition for liquid crystal alignment layer comprises a norbornene-based polymer having a photoreactive group, a binder, a reactive mesogen, and a photoinitiator.

### TECHNICAL FIELD

The present invention relates to a composition for liquid crystal alignment layer, a liquid crystal alignment layer, and a liquid crystal cell. More particularly, the present invention relates to a composition for liquid crystal alignment layer used to provide a liquid crystal alignment layer that exhibits excellent alignment and maintains stable alignment without disturbance despite external stress such as electrical/thermal stress, a liquid crystal alignment layer, and a liquid crystal cell.

This application claims priority from Korean Patent Application No. 10-2010-0053696 filed on Jun. 8, 2010 in the Korean Intellectual Property Office (KIPO), the disclosure of which is incorporated herein by reference in its entirety.

### BACKGROUND OF ART

In recent years, as a liquid crystal display has become bigger, its application has been expanded from personal use such as mobile phones or notebook computers to home use such as wall-mountable television sets, and thus it is required to ensure the high definition, the high quality, and the wide viewing angle in respects to the liquid crystal display. In particular, since individual pixels operate independently, thin film transistor-liquid crystal displays (TFT-LCD) driven by a thin film transistor exhibit a very fast response speed of liquid crystals, and thus make it possible to realize a high definition dynamic image and are gradually expanding boundaries of their application.

In order to use liquid crystals as an optical switch in TFT-LCDs, liquid crystals need to be initially aligned in a predetermined direction on a TFT layer which is disposed in the most inner portion of a display cell. For this purpose, a liquid crystal alignment layer is used.

A current method of aligning liquid crystals in liquid crystal display, which is called as a “rubbing process,” includes applying a thermal resistant polymer such as a polyimide on a transparent glass to form a polymer alignment layer and rubbing the alignment layer with a rapidly rotating roller wound with a rubbing cloth made of nylon or rayon to impart an orientation.

However, since the rubbing process may cause mechanical scratches on the surface of a liquid crystal alignment material or generate high static charges, a thin film transistor is destroyed. In addition, a defect occurs due to fine fibers generated from the rubbing cloth, which hinders the improvement in production yield.

In order to overcome these problems of the rubbing process and to make innovation in terms of productivity, a newly designed manner of orienting liquid crystals is a UV-induced (i.e., light-induced) alignment of liquid crystals (hereinafter, referred to as “photoalignment”).

Photoalignment refers to a mechanism, in which photosensitive groups connected to a photoreactive polymer generates a photoreaction due to linearly polarized UV, and in this procedure, a main chain of the polymer is unidirectionally aligned, thereby forming a photopolymerizable liquid crystal alignment layer in which the liquid crystals are aligned.

Representative examples thereof are the photoalignment through photopolymerization, which is announced by M. Schadt et al., (U.S. Pat. No. 5,602,661, Jpn. J. Appl. Phys., Vol 31., 1992, 2155), Dae S. Kang et al., (U.S. Pat. No. 5,464,669), Yuriy Reznikov (Jpn. J. Appl. Phys. Vol. 34, 1995, L1000).

In these patent and papers, polycinnamate-based polymers such as PVCN (poly(vinyl cinnamate)) and PVMC (poly(vinyl methoxycinnamate)) are mainly used as a photoalignment polymer. In the case of performing the photoalignment, the cycloaddition reaction [2+2] of the double bond [2+2] of cinnamate by UV irradiation forms cyclobutane, and thus anisotropy is generated to unidirectionally align liquid crystal molecules, leading to the alignment of the liquid crystals.

However, when the known photoalignment polymers or alignment compositions including the same are applied to the alignment layer of a TFT-Cell, problems in terms of alignment layer stability or image sticking of liquid crystal cells are generated. That is, when the prior photoalignment polymers or the like are applied, the photoalignment polymers in the alignment layer may exhibit poor stability because of external stress such as electrical/thermal stress, and furthermore disturbance in the alignment itself may occur, which causes a flicker of the liquid crystal cell. Therefore, there is a continuous demand for the development of alignment layers or alignment materials that are able to maintain stable alignment without disturbance despite external stress and have no flicker problem.

### SUMMARY OF THE INVENTION

Accordingly, the present invention provides a composition for liquid crystal alignment layer used to provide a liquid crystal alignment layer that exhibits excellent alignment and maintains stable alignment without disturbance despite external stress such as electrical/thermal stress.

Further, the present invention provides a liquid crystal alignment layer that comprises the composition for liquid crystal alignment layer and thus, maintains stable alignment and has no flicker problem.

Further, the present invention provides a liquid crystal cell comprising the liquid crystal alignment layer.

The present invention provides a composition for liquid crystal alignment layer, comprising a norbornene-based polymer having a photoreactive group, a binder, a reactive mesogen and a photoinitiator.

Further, the present invention provides a method for manufacturing a liquid crystal alignment layer, comprising the steps of applying the composition for liquid crystal alignment layer on a substrate; and irradiating UV rays on the applied composition.

Further, the present invention provides a liquid crystal alignment layer comprising the composition for liquid crystal alignment layer.

Further, the present invention provides a liquid crystal cell comprising the liquid crystal alignment layer.

### DESCRIPTION OF THE EMBODIMENT

Hereinafter, a composition for liquid crystal alignment layer, a method for manufacturing a liquid crystal alignment layer, a liquid crystal alignment layer, and a liquid crystal cell according to embodiments of the invention will be described.

One embodiment of the invention provides a composition for liquid crystal alignment layer comprising a norbornene-based polymer having a photoreactive group, a binder, a reactive mesogen and a photoinitiator.

The composition for liquid crystal alignment layer of one embodiment comprises a norbornene-based polymer having a photoreactive group. The norbornene-based polymer may have a repeating unit consisting of a norbornene-based ring as a main chain, in which the norbornene-based ring is substituted with one or more photoreactive groups. The substitution of the norbornene-based polymer with the photoreactive groups generates a photoreaction by UV irradiation. As a result of UV curing, an orientation is induced according to a UV polarization direction, leading to photoalignment.

In the norbornene-based polymer, the photoreactive groups bind as a substituent of the norbornene-based ring rather than bind to a side chain of the polymer. When the prior known photoalignment polymers are used, alignment disturbance by external stress may be attributed that the photoreactive groups bind to the side chain of the polymer and thus, the unreacted photoreactive groups after UV irradiation affect the entire alignment. In the norbornene-based polymer included in the composition of one embodiment, however, the photoreactive groups bind as a substituent of the norbornene-based ring, and thus there is little concern about effects of the unreacted photoreactive groups on the alignment disturbance.

Further, the composition for liquid crystal alignment layer of one embodiment comprises a reactive mesogen (RM). The reactive mesogen refers to a material that is polymerized by UV irradiation and shows liquid crystal phase behavior, and the definition will be apparent to those skilled in the art. When the alignment material, namely, the norbornene-based polymer is photo-aligned by UV irradiation, the reactive mesogen can be aligned according to the orientation of the alignment material, and can be also polymerized and/or cured by UV irradiation. The alignment of the alignment material in the alignment layer can be stabilized by the reactive mesogen that is aligned in a predetermined direction and cured. As a result, the liquid crystal alignment layer obtained from the composition of one embodiment exhibits excellent alignment, maintains stable alignment despite external stress such as electrical/thermal stress, and generates little concern about flicker problem.

Therefore, the composition of one embodiment can be used to provide a liquid crystal alignment layer having excellent characteristics.

Hereinafter, each component of the composition for liquid crystal alignment layer according to one embodiment of the invention will be described in more detail.

The composition comprises a reactive mesogen. The reactive mesogen refers to a material that can be polymerized and/cured by UV irradiation and contains a mesogenic group to show liquid crystal phase behavior. Any liquid crystal phase material can be used as the reactive mesogen without limitation, as long as it has such characteristics. However, a compound of the following Chemical Formula 1 is preferred in order to stabilize the alignment of a liquid crystal alignment layer by interaction with the norbornene-based polymer having a photoreactive group, and to form an alignment layer having excellent physical properties by appropriately polymerizing and/or curing with a binder:

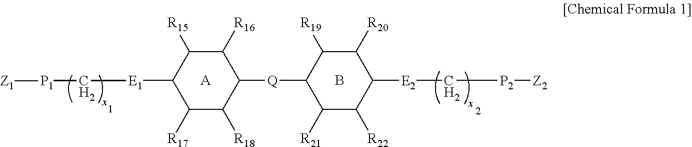

wherein A and B is selected from the group consisting of an arylene group having 6 to 40 carbon atoms and a cycloalkylene group having 6 to 8 carbon atoms, R₁₅ to R₂₂ are each independently or simultaneously H, F, Cl, CN, an alkyl group having 1 to 12 carbon atoms, an aryl group having 6 to 40 carbon atoms, an alkoxy group having 1 to 12 carbon atoms, and an alkoxycarbonyl group having 1 to 12 carbon atoms, E₁ and E₂ are each independently or simultaneously a chemical bond, —O—, —S—, —CO—, —COO—, —COO—, —CH═CH—COO—, —OCO—CH═CH—, —C═C—, —OCH₂— or —CH₂O—, Z₁ and Z₂ are each independently an acrylate group or a methacrylate group, P₁, P₂, and Q are each independently or simultaneously one of A, E, and Z, and x₁ and x₂ are each independently an integer of 0 to 12.

Further, in terms of excellent photoalignment and alignment stability, A and B in Chemical Formula 1 are phenylene or cyclohexylene, and at least one of A and B is most preferably phenylene.

The compound of Chemical Formula 1 may be prepared by a method known to those skilled in the art, or may be commercially available.

Further, the composition of one embodiment comprises a norbornene-based polymer having a photoreactive group. The norbornene-based polymer may comprise a repeating unit of the following Chemical Formula 3 or 4:

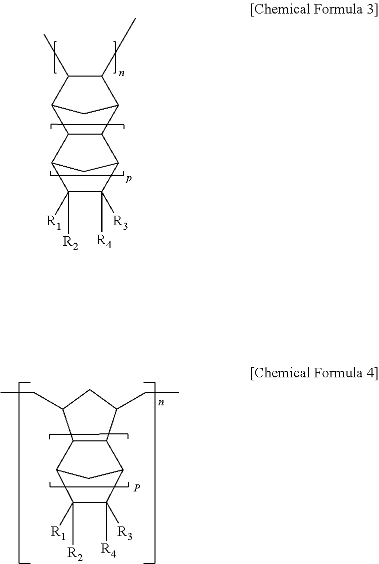

wherein n is 50 to 5,000, p is an integer of 0 to 4, at least one of R₁, R₂, R₃, and R₄ is a radical selected from the group consisting of the following Chemical Formulae 2a, 2b and 2c, and the others are the same as or different from each other, and each independently hydrogen; halogen; substituted or unsubstituted alkyl having 1 to 20 carbon atoms; substituted or unsubstituted alkenyl having 2 to 20 carbon atoms; substituted or unsubstituted cycloalkyl having 5 to 12 carbon atoms; substituted or unsubstituted aryl having 6 to 40 carbon atoms; substituted or unsubstituted aralkyl having 7 to 15 carbon atoms; substituted or unsubstituted alkynyl having 2 to 20 carbon atoms; and a polar functional group selected from the group consisting of non-hydrocarbonaceous polar groups containing one or more elements selected from the group consisting of oxygen, nitrogen, phosphorous, sulfur, silicon and boron, and if R₁, R₂, R₃, and R₄ are not hydrogen, halogen, or a polar functional group, R₁ and R₂ or R₃ and R₄ are linked to each other to form an alkylidene group having 1 to 10 carbon atoms, or R₁ or R₂ is linked to any one of R₃ and R₄ to form a saturated or unsaturated ring having 4 to 12 carbon atoms or an aromatic ring having 6 to 24 carbon atoms,

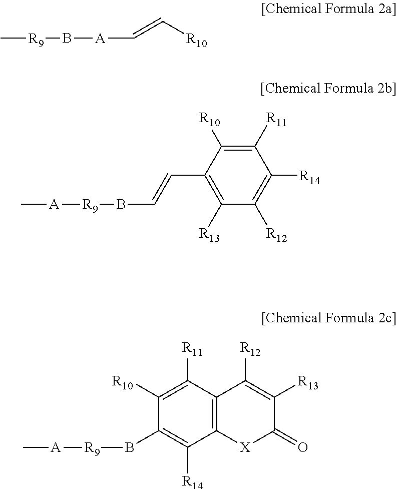

wherein A is selected from the group consisting of a chemical bond, substituted or unsubstituted alkylene having 1 to 20 carbon atoms, carbonyl(—CO—), carbonyloxy(—(CO)O—), substituted or unsubstituted arylene having 6 to 40 carbon atoms, and substituted or unsubstituted heteroarylene having 6 to 40 carbon atoms, B is selected from the group consisting of a chemical bond, oxygen, sulfur, and —NH—, X is oxygen or sulfur, R₉ is selected from the group consisting of a chemical bond, substituted or unsubstituted alkylene having 1 to 20 carbon atoms, substituted or unsubstituted alkenylene having 2 to 20 carbon atoms, substituted or unsubstituted cycloalkylene having 5 to 12 carbon atoms, substituted or unsubstituted arylene having 6 to 40 carbon atoms, substituted or unsubstituted aralkylene having 7 to 15 carbon atoms, and substituted or unsubstituted alkynylene having 2 to 20 carbon atoms, R₁₀, R₁₁, R₁₂, R₁₃, and R₁₄ are the same as or different from each other, and each independently selected from the group consisting of substituted or unsubstituted alkyl having 1 to 20 carbon atoms; substituted or unsubstituted alkoxy having 1 to 20 carbon atoms; substituted or unsubstituted aryloxy having 6 to 30 carbon atoms; substituted or unsubstituted aryl having 6 to 40 carbon atoms; hetero aryl having 6 to 40 carbon atoms containing hetero elements of Group 14, 15 or 16; substituted or unsubstituted alkoxyaryl having 6 to 40 carbon atoms and a halogen atom.

In the norbornene-based polymer, at least one of R₁, R₂, R₃, and R₄ of the norbornene-based ring is substituted with photoreactive groups of Chemical Formulae 2a to 2c, thereby excellent photoreactivity and photoalignment, and the structurally rigid norbornene-based ring contributes to excellent thermal stability.

In terms of excellent alignment, interaction with the reactive mesogen and excellent alignment stability of the liquid crystal alignment layer, it is preferable that in the repeating unit of Chemical Formula 3 or 4, R₁ is a cinnamate-based photoreactive group represented by Chemical Formula 2b, and at least one of R₂, R₃, and R₄ is a photoreactive group selected from the group consisting of Chemical Formulae 2a, 2b and 2c. More particularly, in terms of excellent alignment, the end of the photoreactive group is preferably substituted with one or more halogen atoms such as fluorine, and in terms of miscibility with a solvent in the composition for liquid crystal alignment layer or in terms of substrate-coating property, the end of the photoreactive group is preferably substituted with one or more alkyl, alkoxy or aryloxy.

In the repeating units of Chemical Formulae 3 and 4, the non-hydrocarbonaceous polar group may be selected from the group consisting of the following functional groups, and other various polar functional groups are also possible:

—OR₆, —OC(O)OR₆, —R₅OC(O)OR₆, —C(O)OR₆, —R₅C(O)OR₆, —C(O)R₆, —R₅C(O)R₆, —OC(O)R₆, —R₅OC(O)R₆, —(R₅₀)ₖ—OR₆, —(OR₆)ₖ—OR₆, —C(O)—O—C(O)R₆, —R₅C(O)—O—C(O)R₆, —SR₆, —R₅SR₆, —SSR₆, —R₅SSR₆, —S(═O)R₆, —R₅S(═O)R₆, —R₅C(═S)R₆—, —R₅C(═S)SR₆, —R₅SO₃R₆, —SO₃R₆, —R₅N═C═S, —N═C═S, —NCO, —R₅—NCO, —CN, —R₅CN, —NNC(═S)R₆, —R₅NNC(═S)R₆, —NO₂, —R₅NO₂,

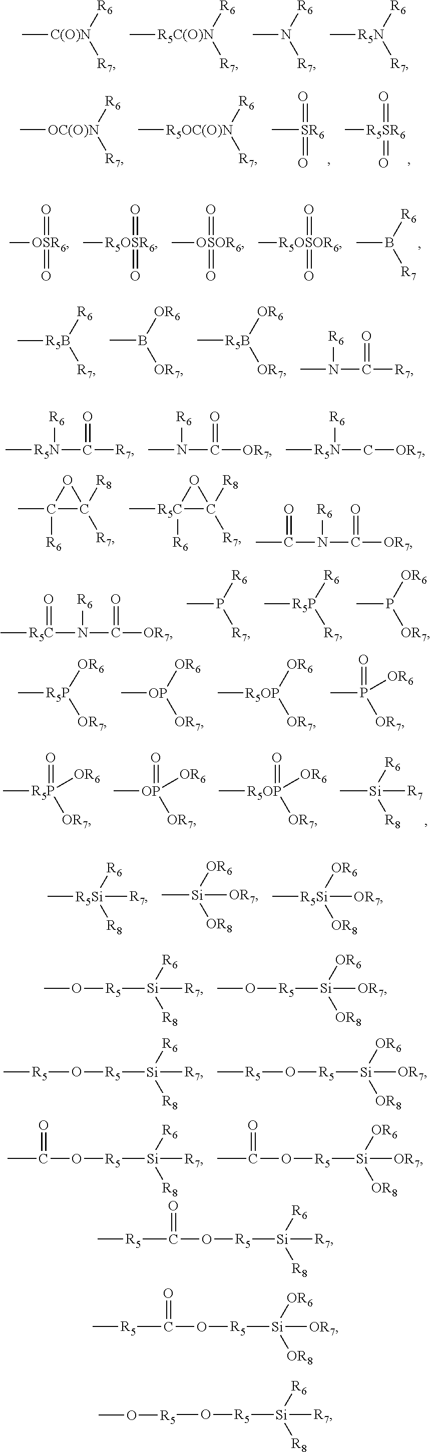

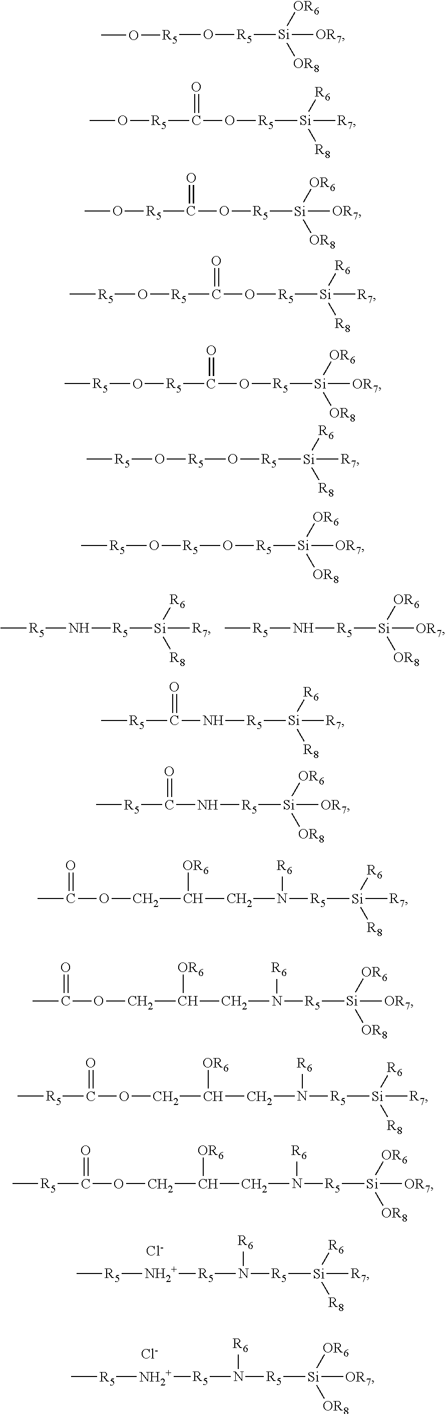

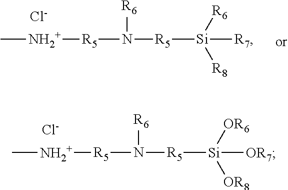

wherein R₅ is the same as or different from each other, and each independently linear or branched alkylene that has 1 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; linear or branched alkenylene that has 2 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; linear or branched alkynylene that has 3 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; cycloalkylene that has 3 to 12 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; arylene that has 6 to 40 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; alkoxylene that has 1 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; carbonyloxylene that has 1 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy,

R₆, R₇ and R₈ are the same as or different from each other, and each independently hydrogen; halogen; linear or branched alkyl that has 1 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; linear or branched alkenyl that has 2 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; linear or branched alkynyl that has 3 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; cycloalkyl that has 3 to 12 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; aryl that has 6 to 40 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; alkoxy that has 1 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; carbonyloxy that has 1 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy, and k is each independently an integer of 1 to 10.

Further, in the repeating units of Chemical Formulae 3 and 4, the hetero aryl having 6 to 40 carbon atoms containing hetero elements of Group 14, 15 or 16, or the aryl group having 6 to 40 carbon atoms may be one or more selected from the group consisting of the following functional groups, but is not limited thereto:

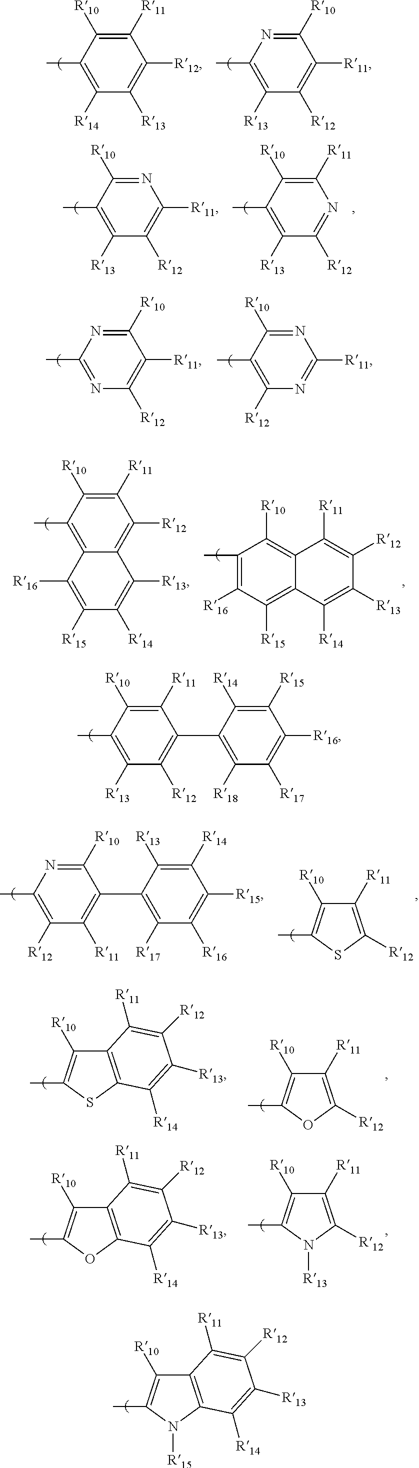

wherein at least one of R′₁₀, R′₁₁, R′₁₂, R′₁₃, R′₁₄, R′₁₅, R′₁₆, R′₁₇, and R′₁₈ is substituted or unsubstituted alkoxy having 1 to 20 carbon atoms or substituted or unsubstituted aryloxy having 6 to 30 carbon atoms,

the others are the same as or different from each other, and each independently substituted or unsubstituted alkyl having 1 to 20 carbon atoms, substituted or unsubstituted alkoxy having 1 to 20 carbon atoms, substituted or unsubstituted aryloxy having 6 to 30 carbon atoms, or substituted or unsubstituted aryl having 6 to 40 carbon atoms.

The above described norbornene-based polymer may be a homopolymer containing a single repeating unit of Chemical Formula 3 or 4, but may be a copolymer containing two or more repeating units selected from Chemical Formulae 3 and 4. Furthermore, it may be a copolymer containing other types of repeating units, as long as they do not hinder the excellent properties according to the repeating units of Chemical Formulae 3 and 4.

Meanwhile, the detailed definition of each substituent in the structure of the aforementioned norbornene-based polymer is as follows:

First, the term “alkyl” means a straight or branched, saturated monovalent hydrocarbon with 1 to 20 carbon atoms, preferably 1 to 10 carbon atoms, and more preferably 1 to 6 carbon atoms. The alkyl group may encompass those that are unsubstituted or further substituted with a specific substituent described below. Examples of the alkyl group include methyl, ethyl, propyl, 2-propyl, n-butyl, iso-butyl, tert-butyl, pentyl, hexyl, dodecyl, fluoromethyl, difluoromethyl, trifluoromethyl, chloromethyl, dichloromethyl, trichloromethyl, iodomethyl, bromomethyl, and the like.

The term “alkenyl” means a linear or branched, monovalent hydrocarbon of 2 to 20 carbon atoms, preferably 2 to 10 carbon atoms, and more preferably 2 to 6 carbon atoms, which includes one or more carbon-carbon double bonds. The alkenyl group may be bound through a carbon atom including a carbon-carbon double bond or a saturated carbon atom. The alkenyl group may encompass those that are unsubstituted or further substituted with a specific substituent described below. Examples of the alkenyl group include ethenyl, 1-prophenyl, 2-prophenyl, 2-butenyl, 3-butenyl, pentenyl, 5-hexenyl, dodecenyl or the like.

The term “cycloalkyl” means a saturated or unsaturated non-aromatic monovalent monocyclic, bicyclic, or tricyclic hydrocarbon of 3 to 12 cyclic carbon atoms, and may encompass those that are further substituted with a specific substituent described below. Examples of the cycloalkyl group include cyclopropyl, cyclobutyl, cyclopentyl, cyclopentenyl, cyclohexyl, cyclohexenyl, cycloheptyl, cyclooctyl, decahydronaphtalenyl, adamantyl, norbornyl (e.g., bicyclo[2,2,1]hept-5-enyl) or the like.

The term “aryl” means a monovalent monocyclic, bicyclic, or tricyclic aromatic hydrocarbon having 6 to 40, preferably 6 to 12 cyclic atoms, and may encompass those that are further substituted with a specific substituent described below. Examples of the aryl group may include phenyl, naphthalenyl, fluorenyl or the like.

The term “alkoxyaryl” means that one or more hydrogen atoms of the aryl group defined as described above are substituted with the alkoxy group. Examples of the alkoxyaryl group may include methoxyphenyl, ethoxyphenyl, propoxyphenyl, butoxyphenyl, pentoxyphenyl, heptoxyphenyl, heptoxy, octoxy, nanoxy, methoxybiphenyl, methoxynaphthalenyl, methoxyfluorenyl, methoxyanthracenyl or the like.

The term “aralkyl” means that one or more hydrogen atoms of the alkyl group defined as described above are substituted with the aryl group, and may encompass those that are further substituted with a specific substituent described below. Examples of the aralkyl may include benzyl, benzhydril, tritile or the like.

The term “alkynyl” means a linear or branched, monovalent hydrocarbon of 2 to 20 carbon atoms, preferably 2 to 10 carbon atoms, and more preferably 2 to 6 carbon atoms, which includes one or more carbon-carbon triple bonds. The alkynyl group may be bound through a carbon atom including a carbon-carbon triple bond or a saturated carbon atom. The alkynyl group may encompass those that are further substituted with a specific substituent described below. Examples of the alkynyl group may include ethynyl, propynyl or the like.

The term “alkylene” means a linear or branched, saturated divalent hydrocarbon of 1 to 20 carbon atoms, preferably 1 to 10 carbon atoms, and more preferably 1 to 6 carbon atoms. The alkylene group may encompass those that are further substituted with a specific substituent described below. Examples of the alkylene group may include methylene, ethylene, propylene, butylene, hexylene or the like.

The term “alkenylene” means a linear or branched, divalent hydrocarbon of 2 to 20 carbon atoms, preferably 2 to 10 carbon atoms, and more preferably 2 to 6 carbon atoms, which includes one or more carbon-carbon double bonds. The alkenylene group may be bound through a carbon atom including a carbon-carbon double bond and/or a saturated carbon atom. The alkenylene group may encompass those that are further substituted with a specific substituent described below.

The term “cycloalkylene” means a saturated or unsaturated non-aromatic divalent monocyclic, bicyclic or tricyclic hydrocarbon having 3 to 12 cyclic carbons, and may encompass those that are further substituted with a specific substituent described below. Examples of the cycloalkylene may include cyclopropylene, cyclobutylene or the like.

The term “arylene” means an aromatic divalent monocyclic, bicyclic or tricyclic hydrocarbon having 6 to 20 cyclic atoms, preferably 6 to 12 cyclic atoms, and may encompass those that are further substituted with a specific substituent described below. The aromatic portion of the arylene group includes carbon atoms only. Examples of the arylene group include phenylene or the like.

The term “aralkylene” means a divalent portion in which one or more hydrogen atoms of the alkyl group defined as described above are substituted with the aryl group, and may encompass those that are further substituted with a specific substituent described below. Examples of the aralkylene group may include benzylene or the like.

The term “alkynylene” means a linear or branched, divalent hydrocarbon of 2 to 20 carbon atoms, preferably 2 to 10 carbon atoms, and more preferably 2 to 6 carbon atoms, which includes one or more carbon-carbon triple bonds. The alkynylene group may be bound through a carbon atom including a carbon-carbon triple bond or a saturated carbon atom. The alkynylene group may encompass those that are further substituted with a specific substituent described below. Examples of the alkynylene group may include ethynylene, propynylene and the like.

The above described, “those substituted or unsubstituted with substituents” means that they encompass those further substituted with a specific substituent as well as each substituent itself. Herein, examples of the substituent further substituted in each substituent may include halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl, siloxy or the like.

Meanwhile, when the above described norbornene-based polymer comprises the repeating unit of Chemical Formula 3, the polymer may be prepared by addition polymerization of the monomers of Chemical Formula 2 in the presence of a catalyst composition containing a Group 10 transition metal precatalyst and a cocatalyst so as to form the repeating unit of Chemical Formula 3:

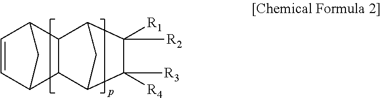

wherein p, R₁, R₂, R₃, and R₄ are the same as defined in Chemical Formula 3.

In this connection, the polymerization may be performed at a temperature of 10° C. to 200° C. If the reaction temperature is lower than 10° C., there is a problem in that polymerization activity may be lowered. If the reaction temperature is higher than 200° C., the catalyst may be decomposed, which is undesirable.

In addition, the cocatalyst may include one or more selected from the group consisting of a first co-catalyst for providing a Lewis base capable of weakly coordinating with the metal of the precatalyst; and a second cocatalyst for providing a compound containing a Group 15 electron donor ligand. Preferably, the cocatalyst may be a catalytic mixture comprising the first cocatalyst for providing a Lewis base, and optionally the second cocatalyst for providing a compound containing a neutral Group 15 electron donor ligand. In this regard, the catalytic mixture may include 1 to 1000 mole of the first cocatalyst, and 1 to 1000 mole of the second cocatalyst, based on 1 mole of the precatalyst. If the content of the first or second cocatalyst is too low, activation of the catalyst may not be properly achieved, and if the content is too high, the catalytic activity may be reduced.

A compound having the Lewis base functional group, which easily participates in a Lewis acid-base reaction to be separated from a core metal, may be used as the precatalyst having Group 10 transition metal so that the Lewis base is easily separated by the first cocatalyst to convert the central transition metal into the catalytic active species. It is exemplified by [(Allyl)Pd(Cl)]₂(Allylpalladiumchloride dimer), (CH₃CO₂)₂Pd [Palladium(II)acetate], [CH₃COCH═C(O—)CH₃]₂Pd [Palladium(II)acetylacetonate], NiBr(NP(CH₃)₃)₄, [PdCl(NB)O(CH₃)]₂ or the like.

Moreover, the first cocatalyst for providing the Lewis base capable of weakly coordinating with the metal of the precatalyst may include a compound, which easily reacts with the Lewis base to form vacancies in the transition metal and which weakly coordinates with the transition metal compound, in order to stabilize the transition metal or another compound for providing this. It is exemplified by borane such as B(C₆F₅)₃, borate such as dimethylanilinium tetrakis(pentafluorophenyl)borate, alkyl aluminum such as methyl aluminoxane (MAO) or Al(C₂H₅)₃, or transition metal halide such as AgSbF₆.

The second cocatalyst for providing a compound containing a neutral Group 15 electron donor ligand may be alkyl phosphine, cycloalkyl phosphine or phenyl phosphine.

Further, the first cocatalyst and the second cocatalyst may be used separately, or these cocatalysts may be prepared into a single salt, and used as a compound activating the catalyst. It is exemplified by a compound prepared by an ionic bond of alkyl phosphine and a borane or borate compound.

The repeating unit of Chemical Formula 3 and the norbornene-based polymer including the same may be prepared by the above described method.

Meanwhile, if the norbornene-based polymer includes the repeating unit of Chemical Formula 4, the polymer may be prepared by ring-opening polymerization of the monomers of Chemical Formula 2 in the presence of a catalyst composition containing a Group 4, 6, or 8 transition metal precatalyst and a cocatalyst so as to form the repeating unit of Chemical Formula 4.

In the ring-opening polymerization, the ring-opening reaction may be performed by addition of hydrogens to the double bond of the norbornene ring included in the monomer of Chemical Formula 2, and the repeating unit of Chemical Formula 4 and the photoreactive polymer including the same may be prepared by polymerization together with the ring-opening reaction.

The ring-opening polymerization may be performed in the presence of a catalytic mixture consisting of a precatalyst having a transition metal of Group 4 (e.g., Ti, Zr, Hf), Group 6 (e.g., Mo, W), or Group 8 (e.g., Ru, Os), a cocatalyst for providing the Lewis base capable of weakly coordinating with the metal of the precatalyst, and optionally, a neutral Group 15 and 16 activator capable of improving the activity of the metal of the precatalyst. In the presence of the catalytic mixture, the polymerization may be also performed at a temperature of 10° C. to 200° C. by addition of 1˜100 mol % of a linear alkene capable of adjusting a molecular weight, such as 1-alkene and 2-alkene, based on the monomer. Subsequently, addition of hydrogens to the double bonds of the norbornene ring may be performed at a temperature of 10° C. to 250° C. by addition of 1 to 30% by weight of the catalyst having a transition metal of Group 4 (e.g., Ti, Zr) or Groups 8 to 10 (e.g., Ru, Ni, Pd), based on the monomer. If the reaction temperature is too low, there is a problem in that polymerization activity is lowed. If the reaction temperature is too high, the catalyst is decomposed, which is undesirable. If the reaction temperature during the hydrogen addition reaction is too low, there is a problem in that activity of the hydrogen addition reaction is lowed. If the reaction temperature is too high, the catalyst is decomposed, which is undesirable.

The catalytic mixture includes 1 to 100,000 mole of the cocatalyst for providing the Lewis base capable of weakly coordinating with the metal of the precatalyst based on 1 mole of the precatalyst having a transition metal of Group 4 (e.g., Ti, Zr, Hf), Group 6 (e.g., Mo, W), or Group 8 (e.g., Ru, Os), and optionally, 1 to 100 mole of the neutral Group 15 and 16 activator capable of improving the activity of the metal of the precatalyst, based on 1 mole of the precatalyst.

If the content of the cocatalyst is less than 1 mole, there is a problem in that the activation of the catalyst is not obtained. If the content of the cocatalyst is more than 100,000 mole, the catalytic activity is reduced, which is undesirable. The activator may not be needed depending on the type of the precatalyst. If the content of the activator is less than 1 mole, there is a problem in that the activation of the catalyst is not obtained. If the content of the activator is more than 100 mole, the molecular weight is reduced, which is undesirable.

If the content of the catalyst having a transition metal of Group 4 (e.g., Ti, Zr) or Groups 8 to 10 (e.g., Ru, Ni, Pd) used in the hydrogen addition reaction is less than 1% by weight, based on the monomers, there is a problem in that the hydrogen addition does not occur. If the content is more than 30% by weight, undesirable discoloration of the polymer occurs.

The precatalyst having a transition metal of Group 4 (e.g., Ti, Zr, Hf), Group 6 (e.g., Mo, W), or Group 8 (e.g., Ru, Os) may refer to TiCl₄, WCl₆, MoCl₆, RuCl₃ or ZrCl₄, which is a transition metal compound having a functional group that easily participates in a Lewis acid-base reaction to be separated from a core metal, so that the Lewis base is easily separated by the cocatalyst for providing a Lewis acid to convert the central transition metal into the catalytic active species.

Further, examples of the cocatalyst for providing a Lewis base capable of weakly coordinating with the metal of the precatalyst may include boranes such as B(C₆F₅)₃, borates, alkyl aluminums such as methylaluminoxane (MAO), Al(C₂H₅)₃, and Al(CH₃)Cl₂, alkyl aluminum halides, and aluminum halides. Alternatively, substituents such as lithium, magnesium, germanium, lead, zinc, tin, silicon may be used instead of aluminum, which easily reacts with the Lewis base to form vacancies in the transition metal and which weakly coordinates with the transition metal compound, in order to stabilize the transition metal or another compound for providing this.

The polymerization activator may be added, but may not be needed depending on the type of precatalyst. Examples of the neutral Group 15 and 16 activator capable of improving the activity of the metal of the precatalyst include water, methanol, ethanol, isopropyl alcohol, benzyl alcohol, phenol, ethyl mercaptan, 2-chloroethanol, trimethylamine, triethylamine, pyridine, ethylene oxide, benzoyl peroxide, and t-butyl peroxide.

The catalyst having a transition metal of Group 4 (e.g., Ti, Zr) or Groups 8 to 10 (e.g., Ru, Ni, Pd) used in the hydrogen addition reaction is miscible with a solvent to form a homogeneous solution, or the metal catalyst complex is supported on support particles. Preferred examples of the support particles include silica, titania, silica/chromia, silica/chromia/titania, silica/alumina, aluminium phosphate gel, silanized silica, silica hydrogel, montmorillonite clay and zeolite.

The repeating unit of Chemical Formula 4 and the norbornene-based polymer including the same may be prepared by the above described method.

Meanwhile, in the composition for liquid crystal alignment layer of one embodiment, the above described norbornene-based polymer and the reactive mesogen may be preferably included in a weight ratio of 1:0.1 to 1:2. If the content of the reactive mesogen is too low and thus the weight ratio is less than 1:0.1, it is difficult to achieve the desired alignment stability, and a flicker problem may be caused by external stress. If the content of the reactive mesogen is too high and thus the weight ratio is more than 1:2, the alignment of the liquid crystal alignment layer itself may be reduced.

Further, the composition for liquid crystal alignment layer of one embodiment includes a binder, together with the above described reactive mesogen and norbornene-based polymer. Any polymerizable compounds, oligomers or polymers may be used as the binder without limitation, as long as they are UV-curable to form the alignment layer. However, in terms of preferred polymerization and/or curing, or in terms of excellent physical properties of the liquid crystal alignment layer, methacrylate-based compounds, more particularly, multifunctional methacrylate-based compounds may be used.

The specific examples of the binder may include pentaerythritol triacrylate, tris(2-acrylolyloxyethyl)isocyanurate, trimethylolpropane triacrylate or dipentaerythritol hexaacrylate, and two or more selected therefrom may be used together.

Further, the composition for liquid crystal alignment layer includes a photoinitiator. Any initiator known to initiate and facilitate UV curing may be used as the photoinitiator. For example, an initiator known as the trade name of Irgacure 907 or 819 may be used.

The above described composition for liquid crystal alignment layer may further include an organic solvent in order to dissolve each of the above described components. Examples of the organic solvent may include toluene, anisole, chlorobenzene, dichloroethane, cyclohexane, cyclopentane, and propylene glycol methyl ether acetate, and two or more mixtures thereof may be used. In addition, any other solvent may be used depending on the type of the components, in order to effectively dissolve the components and apply them on a substrate.

The above described composition for liquid crystal alignment layer may include about 40 to 65% by weight of the norbornene-based polymer, about 15 to 35% by weight of the binder, about 10 to 25% by weight of the reactive mesogen, and about 1 to 6% by weight of the photoinitiator, based on the weight of the solid components. In this regard, the weight of the solid components may refer to a total weight of the components, excluding the organic solvent from the components constituting the composition for liquid crystal alignment layer.

Further, a content of the solid components in the composition for liquid crystal alignment layer may be about 1 to 15% by weight, thereby providing the desired alignment property and the preferred coating property of the composition. More particularly, when the liquid crystal alignment layer is intended to be cast in a film form, the content of the solid components may be about 10 to 15% by weight. When it is intended to be formed in a thin layer, the content of the solid components may be about 1 to 5% by weight.

Meanwhile, another embodiment of the invention provides a method for manufacturing a liquid crystal alignment layer using the above described composition for liquid crystal alignment layer. The method may include the steps of applying the above described composition for liquid crystal alignment layer on a substrate; optionally, drying a solvent included in the applied composition; and irradiating UV rays on the applied composition.

When UV irradiation is performed after applying the composition and removing the solvent, photoalignment of the photoreactive groups substituted in the norbornene-based polymer occurs, and UV polymerization and/or curing of the reactive mesogen and the binder occurs, leading to formation of the liquid crystal alignment layer. During this process, the reactive mesogen can be aligned in a predetermined direction according to the orientation of the norbornene-based polymer. As a result, the liquid crystal alignment layer maintains stable alignment despite external stress such as electrical/thermal stress, and has no flicker problem.

In the step of applying the composition in the method for manufacturing an alignment layer, the solution concentration, the solvent type, and the coating method may be determined according to the particular type of the norbornene-based polymer, the reactive mesogen, the binder and the photoinitiator. However, the coating method may include a roll coating method, a spin coating method, a printing method, an ink jet spraying method, and a slit nozzle method. Through this method, the composition for liquid crystal alignment layer may be applied on the surface of a substrate that is formed by patterning a transparent conductive layer or a metal electrode.

Additionally, in order to further improve adhesion to the substrate, a functional silane-containing compound, a functional fluorine-containing compound or a functional titanium-containing compound may be applied on the substrate in advance.

In the step of drying a solvent, drying is performed by heating the coated film or by vacuum evaporation, so as to remove the solvent. The drying step may be performed at 50 to 250° C. for about 20 to 90 minutes.

Further, in the step of irradiating UV rays, polarized UV rays having a wavelength of about 150 to 450 nm may be irradiated on the surface of the dried film. In this regard, the intensity of the UV irradiation may vary depending on the norbornene-based polymer or the type of the photoreactive group bound thereto, but the energy density of about 50 mJ/cm² to 10 J/cm², preferably about 500 mJ/cm² to 5 J/cm², may be irradiated.

The UV rays are subjected to the polarizing treatment by using a method in which UV rays are penetrated through or reflected by (1) a polarizing device using a substrate, in which a dielectric anisotropic material is coated on the surface of the transparent substrate such as quartz glass, sodalime glass, or sodalime-free glass, (2) a polarizing plate on which aluminium or metal wire is finely deposited, or (3) a Bruster polarizing device using reflection by quartz glass. At this time, the polarized UV rays may be irradiated on the composition of the substrate. The polarized UV rays may be irradiated in a direction that is vertical to the surface of the substrate, or may be irradiated at a predetermined incident angle.

Further, the substrate temperature, when UV rays are irradiated, may be around room temperature. However, according to circumstances, UV rays heated to a temperature of about 100° C. or less may be irradiated.

The liquid crystal alignment layer manufactured by the above described method may have a thickness of about 30 to 1000 nm.

Meanwhile, still another embodiment of the invention provides a liquid crystal cell comprising the liquid crystal alignment layer. The liquid crystal cell may include a substrate and a liquid crystal alignment layer formed on the substrate. The liquid crystal cell may be manufactured according to a typical method known in the art. For example, after a photoreactive adhesive including a ball spacer is applied on ends of any one glass substrate of two glass substrates having the liquid crystal alignment layer, the other glass substrate is attached thereto, UV rays are irradiated on the adhesive-applied portion, and the cell is attached thereto. Subsequently, the liquid crystal is injected into the manufactured cell and is subjected to heat treatment, thereby manufacturing the liquid crystal cell.

Practically, the liquid crystal cell provided with the liquid crystal alignment layer exhibits excellent liquid crystal alignment, and also maintains the excellent liquid crystal alignment even after a thermal stability test for a long period of time.

According to the present invention, provided is the liquid crystal alignment layer that exhibits excellent liquid crystal alignment, maintains stable alignment without disturbance despite external stress such as electrical/thermal stress, and has no flicker. The liquid crystal alignment layer can be provided from the composition including a reactive mesogen and a norbornene-based polymer having a photoreactive group.

### EXAMPLES

Hereinafter, the preferred Examples are provided for better understanding. However, the following Examples are for illustrative purposes only, and the invention is not intended to be limited by these Examples.

### Preparation Example 1

### Synthesis of 4-fluoro cinnamic acid

4-Fluoro benzaldehyde (10 g, 80.6 mol), malonic acid (29.5 g, 2 eq.), and piperidine (1.21 g, 0.1 eq.) were added to pyridine (33.7 g, 3 eq.), and the mixture was stirred at room temperature for about 1 hour. The temperature was raised to 80° C., and then the mixture was stirred for 12 hours. After the reaction, the temperature was reduced to room temperature, and 1 M HCl was slowly added to adjust pH of the solution to approximately 4. The produced powder was filtered and washed with water, and dried in a vacuum oven. Yield: 90%.

¹H-NMR (CDCl₃, ppm): 6.42 (d, 1H) 7.44 (d, 2H) 7.75 (d, 2H) 7.80 (d, 1H).

### Preparation Example 2

### Synthesis of 2-(4-fluoro cinnamic ester)-5-norbornene

4-fluoro cinnamic acid (10 g, 60 mmol), 5-norbornene-2-methanol (7.45 g, 60 mol), and zirconium (IV) acetate hydroxide (0.3 g, 0.02 eq.) were added to toluene (50 ml), and the mixture was stirred. Under N₂ atmosphere, the temperature was raised to 145° C., and azeotropic reflux was performed for 24 hours. After the reaction, the temperature was reduced to room temperature, and 100 v % of ethyl acetate was added. Extraction was performed using 1 M HCl, and the extract was washed with water. An organic layer was dried over Na₂SO₄, and the solvent was evaporated to obtain a highly viscous liquid material. Yield: 68%, Purity (GC): 92%.

### Preparation Example 3

### Polymerization of 2-(4-fluoro cinnamic ester)-5-norbornene

2-(4-fluoro cinnamic ester)-5-norbornene (5 g, 18.4 mmol) was dissolved in toluene (15 ml), and then the solution was stirred for 30 minutes while purging it with N₂. The temperature was raised to 90° C., and Pd(acetate)₂ (4.13 mg, 18.4 μmol) and tris(cyclohexyl)hydrogen phosphino tetrakis(pentafluorobenz)borate (37.2 mg, 38.6 μmol) dissolved in methylene chloride (1 ml) were added, and then stirred at 90° C. for 15 hours. After the reaction, the temperature was reduced to room temperature, and then ethanol was used to give precipitates. The precipitates were filtered and dried in a vacuum oven to prepare a final product NB 1. Yield: 85%, Mw: 158k (PDI=2.88).

### Preparation Example 4

2-(4-Methoxy cinnamic ester)-5-norbornene was prepared using 4-methoxy cinnamic acid instead of 4-fluoro cinnamic acid in Preparation Example 2. Polymerization was performed using 2-(4-methoxy cinnamic ester)-5-norbornene in the same manner as in Preparation Example 3, so as to prepare NB2.

### Preparation Example 5

2-(4-Propoxy cinnamic ester)-5-norbornene was prepared using 4-propoxy cinnamic acid instead of 4-fluoro cinnamic acid in Preparation Example 2. Polymerization was performed using 2-(4-propoxy cinnamic ester)-5-norbornene in the same manner as in Preparation Example 3, so as to prepare NB3.

In the following Examples, LC1057 (RM1) and LC242 (RM5) manufactured by BASF Co., and RM3: RM257 (MERCK) manufactured by MERCK Co., categorized into Chemical Formula 1, were used as a reactive mesogen.

### Example 1

The norbornene-based polymer NB1 prepared in Preparation Example 3 and the mesogen compound RM1 were used in a weight ratio of 1:2, 1:3, 1:4, 2:1, 2:2, and 1% by weight of the methacrylate-based compound, pentaerythritol triacrylate, 0.25% by weight of RM1, and 0.25% by weight of the photoinitiator Irgacure 907 manufactured by Ciba were dissolved in a residual amount of cyclopentanone solvent. The solution was applied on a quartz plate by spin-coating (2000 rpm, 20 sec), and dried at 80° C. for 2 minutes. Then, a light of 15 mw/cm² was irradiated using a UV irradiator (UV-A, UV-B) for 2 minutes to manufacture a liquid crystal alignment layer. At this time, a polarizing plate was disposed in front of a UV lamp.

### Examples 2 and 3

A liquid crystal alignment layer was manufactured in the same manner as in Example 1, except using the reactive mesogen, RM3 or RM5 instead of the reactive mesogen RM1 in Example 1.

### Comparative Example 1

Polyvinylcinnamate (PVCi) and the mesogen RM1 were used in a weight ratio of 1:2, 1:3, 1:4, 2:1, 2:2, and 1% by weight of the methacrylate-based compound, pentaerythritol triacrylate, 0.25% by weight of RM1, and 0.25% by weight of the photoinitiator Irgacure 907 manufactured by Ciba were dissolved in a residual amount of cyclopentanone solvent. The solution was applied on a quartz plate by spin-coating (2000 rpm, 20 sec), and dried at 80° C. for 2 minutes. Then, a light of 15 mw/cm² was irradiated using a UV irradiator (UV-A, UV-B) for 2 minutes to manufacture a liquid crystal alignment layer. At this time, a polarizing plate was disposed in front of a UV lamp.

### Examples 4 to 9 and Comparative Examples 2 to 10

According to the type and content described in the following Table 1, the composition for liquid crystal alignment layer was dissolved in a residual amount of cyclopentanone, and the solution was applied on a glass plate by spin-coating (2000 rpm, 20 sec), and dried at 80° C. for 2 minutes. Then, a light of 15 mw/cm² was irradiated using a UV irradiator for 2 minutes to manufacture liquid crystal alignment layers. At this time, a polarizing plate was disposed in front of a UV lamp.

Additionally, when the following flicker test was performed, a metal patterned glass was used instead of the glass plate.

### Experimental Example

### Anisotropy

Absorbances in vertical direction (A⊥) and in horizontal direction (A//) were determined for the liquid crystal alignment layers manufactured in Examples 1 to 3 and Comparative Example 1 to calculate the anisotropy ((A⊥A//)/(A⊥+A//)) shown in the following Table 1. For determination of UV absorbance, a UV spectrometer was equipped with a polarizing plate to determine the horizontal absorbance and the vertical absorbance. Anisotropy of the photoreactive polymer was determined as an absorbance difference at 300 nm, and anisotropy of the mesogen was determined as an absorbance difference at 380 nm. In this regard, the anisotropy of the mesogen determined as an absorbance difference at 380 nm was calculated with respect to some liquid crystal alignment layers shown in the following Table 1.

TABLE 1

| | | Photoreactive | |
|---|---|---|---|
| | UV | polymer:Mesogen | |
| Example | wavelength | (weight ratio) | Anisotropy |
| Example 1 | 300 nm | NB1:RM1 = 1:2 | 0.0028 |
| | | NB1:RM1 = 1:3 | 0.0031 |
| | | NB1:RM1 = 1:4 | 0.0015 |
| | | NB1:RM1 = 2:1 | 0.0055 |
| | | NB1:RM1 = 2:2 | 0.0054 |
| | 380 nm | NB1:RM1 = 1:4 | 0.041 |
| Example 2 | 300 nm | NB1:RM3 = 1:2 | 0.0028 |
| | | NB1:RM3 = 1:3 | 0.0031 |
| | | NB1:RM3 = 1:4 | 0.0015 |
| | | NB1:RM3 = 2:1 | 0.0055 |
| | | NB1:RM3 = 2:2 | 0.0054 |
| Example 3 | 300 nm | NB1:RM5 = 1:2 | 0.0020 |
| | | NB1:RM5 = 1:3 | 0.0052 |
| | | NB1:RM5 = 1:4 | 0.0042 |
| | | NB1:RM5 = 2:1 | 0.0040 |
| | | NB1:RM5 = 2:2 | 0.0039 |
| | 380 nm | NB1:RM5 = 1:2 | 0.018 |
| | | NB1:RM5 = 1:3 | 0.028 |
| | | NB1:RM5 = 1:4 | 0.025 |
| | | NB1:RM5 = 2:2 | 0.020 |
| Comparative Example 1 | | PVCi:RM1 = 1:2 | 0.0010 |
| | | PVCi:RM1 = 1:3 | 0.0009 |
| | | PVCi:RM1 = 1:4 | 0.0002 |
| | | PVCi:RM1 = 2:1 | 0.0009 |
| | | PVCi:RM1 = 2:2 | 0.0011 |
| | | PVCi:RM1 = 1:2 | 0.001 |
| | | PVCi:RM1 = 1:3 | 0.001 |
| | | PVCi:RM1 = 1:4 | 0.001 |
| | | PVCi:RM1 = 2:2 | 0.0005 |

With reference to Table 1, when the norbornene-based polymer NB1 was used together with the reactive mesogen in Examples 1 to 3, high anisotropy was observed, indicating excellent photoalignment of the alignment layers.

On the contrary, when the different photoreactive polymer such as PVCi was used in Comparative Example 1, very low anisotropy was observed, indicating poor photoalignment of the alignment layer.

Measurement of Black Luminance

A 2 μm spacer-containing sealant was used to attach the liquid crystal alignment substrates manufactured in Examples 4 to 9 and Comparative Examples 2 to 10, and the spacer was cured with UV. IPS liquid crystal was injected via capillary force. The liquid crystal-injected cell was stabilized at 90° C. for about 10 minutes, and polarizing plates were attached to the upper and lower surfaces of the cell in cross. Then, black luminance was measured using a photometer, and shown in Table 2.

As shown in table 2, the overall black luminance was similar to that of the polyimide liquid alignment material (reference).

The polyimide liquid alignment material is known to have excellent liquid crystal alignment and black luminance, and low flickering characteristics, but pre-treatment such as UV irradiation and imidization is required for a long period of time, in order to apply it to the alignment layer. In terms of processing, the materials of Examples are more excellent.

Flicker Test (Measurement of Increasing Luminance Ratio)

A 2 μm spacer-containing sealant was used to attach the liquid crystal alignment substrates manufactured in Examples 4 to 9 and Comparative Examples 2 to 10, and the spacer was cured with UV. IPS liquid crystal was injected via capillary force. The liquid crystal-injected cell was stabilized at 90° C. for about 10 minutes, and polarizing plates were attached to the upper and lower surfaces of the cell in cross. Then, black luminance was measured using a photometer, and an electric field of 60 Hz was applied to the same surface to give stress at 60° C. for 24 hours. Then, black luminance was measured again, and the increased luminance relative to the initial luminance was defined as an increasing luminance ratio, and shown in Table 2. As shown in Table 2, all of Comparative Examples 2 to 9 without the reactive mesogen showed several hundred % of increasing luminance ratio, indicating that they showed no stability under the electrical stress. On the contrary, as in Examples, when the liquid crystal alignment layers were prepared using the norbornene-based polymer together with the reactive mesogen, the increasing luminance ratio was reduced to several ten %, which is close to that of reference. The results suggest that the reactive mesogen plays an important role in the stability of liquid crystal alignment layer.

TABLE 2

| | | | | | | Increasing |
|---|---|---|---|---|---|---|
| | Photoreactive | Reactive | Methacrylate | Photo | Black | luminance |
| | polymer | mesogen | compound | initiator | luminance | ratio |
| Comparative | NB1(2 wt %) | — | 1 wt % | 0.25 wt % | 2.1 | Several |
| Example 2 | | | | | | hundred % |
| Comparative | NB1(2 wt %) | — | 2 wt % | 0.25 wt % | 2.3 | Several |
| Example 3 | | | | | | hundred % |
| Comparative | NB2(2 wt %) | — | 1 wt % | 0.25 wt % | 5.9 | Several |
| Example 4 | | | | | | hundred % |
| Comparative | NB2(2 wt %) | — | 2 wt % | 0.25 wt % | 5.6 | Several |
| Example 5 | | | | | | hundred % |
| Comparative | NB3(2 wt %) | — | 1 wt % | 0.25 wt % | 2.7 | Several |
| Example 6 | | | | | | hundred % |
| Comparative | NB3(2 wt %) | — | 2 wt % | 0.25 wt % | 2.4 | Several |
| Example 7 | | | | | | hundred % |
| Comparative | NB1(1 wt %) | — | 1 wt % | 0.125 wt % | 2.0 | >100% |
| Example 8 | NB2(1 wt %) | | | | | |
| Comparative | NB1(1 wt %) | — | 1 wt % | 0.25 wt % | 2.3 | >100% |
| Example 9 | NB2(1 wt %) | | | | | |
| Comparative | Reference | — | | | 2.0 | 7% |
| Example 10 | | | | | | |
| Example 4 | NB1(2 wt %) | RM1(1 wt %) | 1 wt % | 0.25 wt % | 2.8 | 30% |
| Example 5 | NB2(2 wt %) | RM1(1 wt %) | 1 wt % | 0.25 wt % | 3.0 | 80% |
| Example 6 | NB1(1 wt %) | RM1(1 wt %) | 1 wt % | 0.125 wt % | 2.5 | 23% |
| | NB2(1 wt %) | | | | | |
| Example 7 | NB1(2 wt %) | RM5(1 wt %) | 1 wt % | 0.25 wt % | 2.5 | 28% |
| Example 8 | NB3(2 wt %) | RM5(1 wt %) | 1 wt % | 0.25 wt % | 3.1 | 60% |
| Example 9 | NB1(1 wt %) | RM5(1 wt %) | 1 wt % | 0.25 wt % | 2.3 | 9% |
| | NB2(1 wt %) | | | | | |

Black luminance: cd/cm² (backlight: 5980 cd/cm²)
Reference: Polyimide liquid crystal alignment material
RM1: LC1057 (manufactured by BASF)
RM5: LC242 (manufactured by BASF)

1. A composition for liquid crystal alignment layer comprising a norbornene-based polymer having a photoreactive group, a binder, a reactive mesogen, and a photoinitiator

2. The composition according to claim 1, wherein the reactive mesogen comprises a compound of the following Chemical Formula 1: 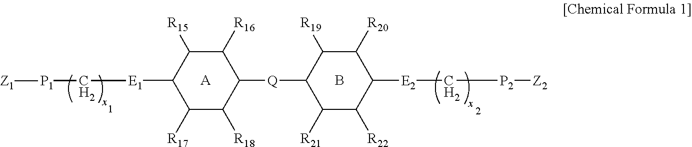
wherein A and B is selected from the group consisting of an arylene group having 6 to 40 carbon atoms and a cycloalkylene group having 6 to 8 carbon atoms,
R₁₅ to R₂₂ are each independently or simultaneously H, F, Cl, CN, an alkyl group having 1 to 12 carbon atoms, an aryl group having 6 to 40 carbon atoms, an alkoxy group having 1 to 12 carbon atoms, and an alkoxycarbonyl group having 1 to 12 carbon atoms,
E₁ and E₂ are each independently or simultaneously a chemical bond, —O—, —S—, —CO—, —COO—, —COO—, —CH═CH—COO—, —OCO—CH═CH—, —C═C—, —OCH₂— or —CH₂O—,
Z₁ and Z₂ are each independently an acrylate group or a methacrylate group,
P₁, P₂, and Q are each independently or simultaneously one of A, E, and Z, and
x₁ and x₂ are each independently an integer of 0 to 12.

3. The composition according to claim 2, wherein any one of A and B of Chemical Formula 1 is phenylene, and the other is phenylene or cyclohexylene.

4. The composition according to claim 1, wherein the norbornene-based polymer having a photoreactive group comprises a repeating unit of the following Chemical Formula 3 or 4: 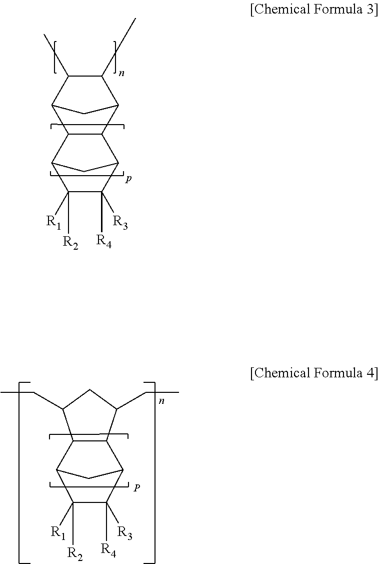
wherein n is 50 to 5,000,
p is an integer of 0 to 4,
any one or more of R₁, R₂, R₃, and R₄ are a radical selected from the group consisting of the following Chemical Formulae 2a, 2b and 2c, and
the others are the same as or different from each other, and each independently hydrogen; halogen; substituted or unsubstituted alkyl having 1 to 20 carbon atoms; substituted or unsubstituted alkenyl having 2 to 20 carbon atoms; substituted or unsubstituted cycloalkyl having 5 to 12 carbon atoms; substituted or unsubstituted aryl having 6 to 40 carbon atoms; substituted or unsubstituted aralkyl having 7 to 15 carbon atoms; substituted or unsubstituted alkynyl having 2 to 20 carbon atoms; and a polar functional group selected from the group consisting of non-hydrocarbonaceous polar groups containing one or more elements selected from the group consisting of oxygen, nitrogen, phosphorous, sulfur, silicon and boron, and
if R₁, R₂, R₃, and R₄ are not hydrogen, halogen, or a polar functional group, R₁ and R₂ or R₃ and R₄ are linked to each other to form an alkylidene group having 1 to 10 carbon atoms, or R₁ or R₂ is linked to any one of R₃ and R₄ to form a saturated or unsaturated ring having 4 to 12 carbon atoms or an aromatic ring having 6 to 24 carbon atoms, 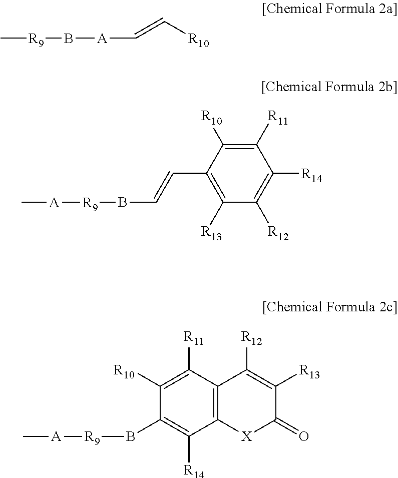
wherein A is selected from the group consisting of a chemical bond, substituted or unsubstituted alkylene having 1 to 20 carbon atoms, carbonyl(—CO—), carbonyloxy(—(CO)O—), substituted or unsubstituted arylene having 6 to 40 carbon atoms, and substituted or unsubstituted heteroarylene having 6 to 40 carbon atoms,
B is selected from the group consisting of a chemical bond, oxygen, sulfur, and —NH—,
X is oxygen or sulfur,
R₉ is selected from the group consisting of a chemical bond, substituted or unsubstituted alkylene having 1 to 20 carbon atoms, substituted or unsubstituted alkenylene having 2 to 20 carbon atoms, substituted or unsubstituted cycloalkylene having 5 to 12 carbon atoms, substituted or unsubstituted arylene having 6 to 40 carbon atoms, substituted or unsubstituted aralkylene having 7 to 15 carbon atoms, and substituted or unsubstituted alkynylene having 2 to 20 carbon atoms,
R₁₀, R₁₁, R₁₂, R₁₃, and R₁₄ are the same as or different from each other, and each independently selected from the group consisting of substituted or unsubstituted alkyl having 1 to 20 carbon atoms; substituted or unsubstituted alkoxy having 1 to 20 carbon atoms; substituted or unsubstituted aryloxy having 6 to 30 carbon atoms; substituted or unsubstituted aryl having 6 to 40 carbon atoms; hetero aryl having 6 to 40 carbon atoms containing hetero elements of Group 14, 15 or 16; substituted or unsubstituted alkoxyaryl having 6 to 40 carbon atoms and a halogen atom.

5. The composition according to claim 4, wherein the non-hydrocarbonaceous polar group is selected from the group consisting of the following functional groups;
—OR₆, —OC(O)OR₆, —R₅OC(O)OR₆, —C(O)OR₆, —R₅C(O)OR₆, —C(O)R₆, —R₅C(O)R₆, —OC(O)R₆, —R₅OC(O)R₆, —(R₅O)ₖ—OR₆, —(OR₅)ₖ—OR₆, —C(O)—O—C(O)R₆, —R₅C(O)—O—C(O)R₆, —SR₆, —R₅SR₆, —SSR₆, —R₅SSR₆, —S(═O)R₆, —R₅S(═O)R₆, —R₅C(═S)R₆—, —R₅C(═S)SR₆, —R₅SO₃R₆, —SO₃R₆, —R₅N═C═S, —N═C═S, —NCO, —R₅—NCO, —CN, —R₅CN, —NNC(═S)R₆, —R₅NNC(═S)R₆, —NO₂, —R₅NO₂, 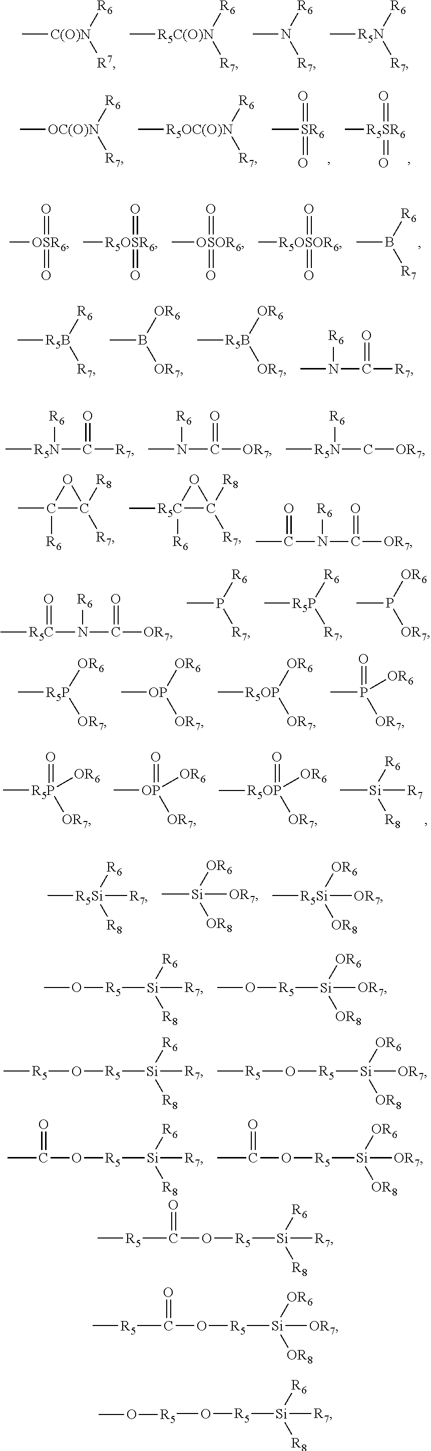 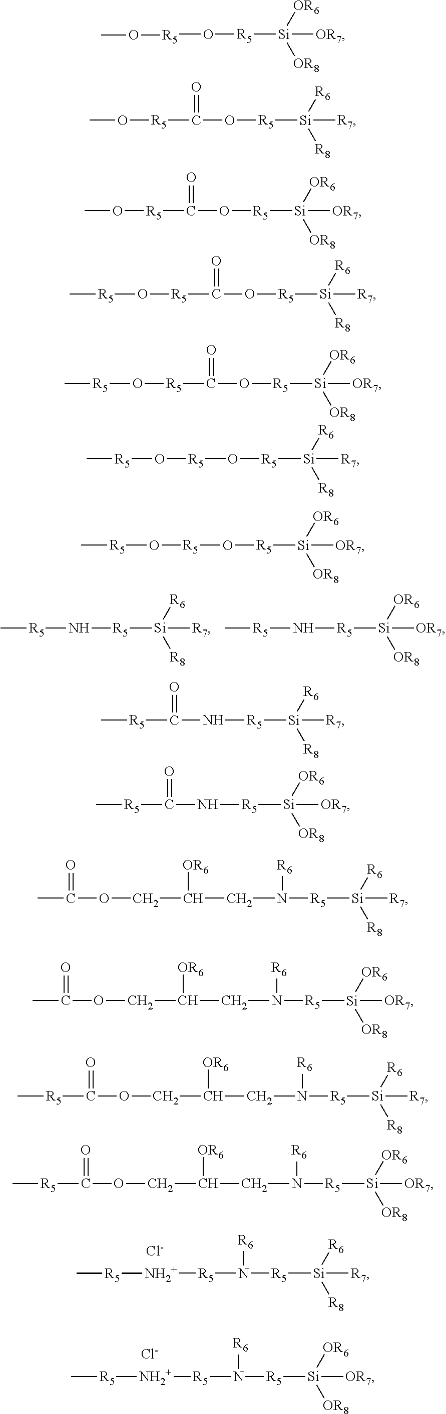 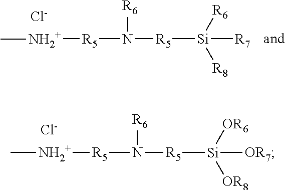
wherein R₅ is the same as or different from each other, and each independently linear or branched alkylene that has 1 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; linear or branched alkenylene that has 2 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; linear or branched alkynylene that has 3 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; cycloalkylene that has 3 to 12 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; arylene that has 6 to 40 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; alkoxylene that has 1 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; carbonyloxylene that has 1 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy,
R₆, R₇ and R₈ are the same as or different from each other, and each independently hydrogen; halogen; linear or branched alkyl that has 1 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; linear or branched alkenyl that has 2 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; linear or branched alkynyl that has 3 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; cycloalkyl that has 3 to 12 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; aryl that has 6 to 40 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; alkoxy that has 1 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy; carbonyloxy that has 1 to 20 carbon atoms and is substituted or unsubstituted with one or more substituent groups selected from the group consisting of halogen, alkyl, alkenyl, alkynyl, haloalkyl, haloalkenyl, haloalkynyl, aryl, haloaryl, aralkyl, haloaralkyl, alkoxy, haloalkoxy, carbonyloxy, halocarbonyloxy, aryloxy, haloaryloxy, silyl and siloxy, and k is each independently an integer of 1 to 10.

6. The composition according to claim 4, wherein the hetero aryl having 6 to 40 carbon atoms containing hetero elements of Group 14, 15 or 16, or the aryl group having 6 to 40 carbon atoms is selected from the group consisting of the following functional groups; 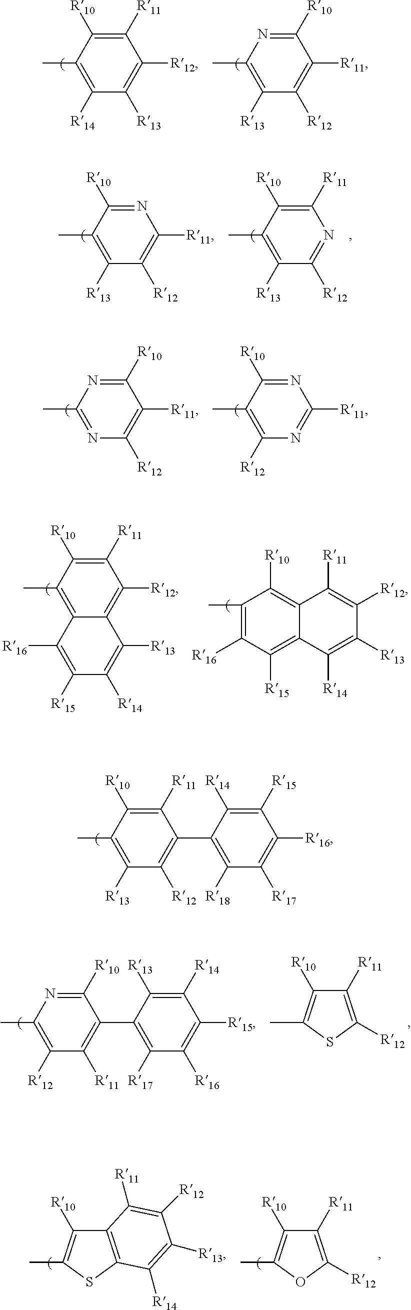 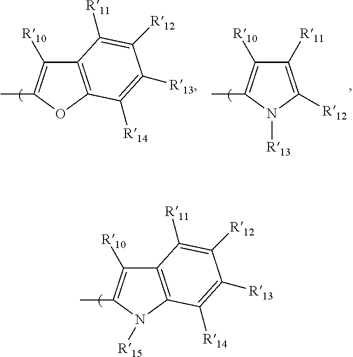
wherein at least one of R′₁₀, R′₁₁, R′₁₂, R′₁₃, R′₁₄, R′₁₅, R′₁₆, R′₁₇, and R′₁₈ is substituted or unsubstituted alkoxy having 1 to 20 carbon atoms or substituted or unsubstituted aryloxy having 6 to 30 carbon atoms,
the others are the same as or different from each other, and each independently substituted or unsubstituted alkyl having 1 to 20 carbon atoms, substituted or unsubstituted alkoxy having 1 to 20 carbon atoms, substituted or unsubstituted aryloxy having 6 to 30 carbon atoms, or substituted or unsubstituted aryl having 6 to 40 carbon atoms.

7. The composition according to claim 4, wherein the norbornene-based polymer having a photoreactive group is a copolymer comprising two or more repeating units selected from the group consisting of Chemical Formulae 3 and 4.

8. The composition according to claim 1, wherein the binder comprises a methacrylate-based compound.

9. The composition according to claim 8, wherein the methacrylate-based compound comprises one or more selected from the group consisting of pentaerythritol triacrylate, tris(2-acrylolyloxyethyl)isocynurate, trimethylolpropane triacrylate and dipentaerythritol hexaacrylate.

10. The composition according to claim 1, wherein the norbornene-based polymer having a photoreactive group and the reactive mesogen are included in a weight ratio of 1:0.1 to 1:2.

11. The composition according to claim 1, wherein the photoinitiator comprises a photoinitiator initiating UV curing.

12. The composition according to claim 1, further comprising one or more organic solvents selected from the group consisting of toluene, anisole, chlorobenzene, dichloroethane, cyclohexane, cyclopentane and propylene glycol methyl ether acetate.

13. The composition according to claim 1, wherein the composition comprises 40 to 65% by weight of the norbornene-based polymer, 15 to 35% by weight of the binder, 10 to 25% by weight of the reactive mesogen, and 1 to 6% by weight of the photoinitiator, based on the total weight of the solid components of the composition.

14. The composition according to claim 12, wherein the content of the solid components is 1 to 15% by weight.

15. A method for manufacturing a liquid crystal alignment layer, comprising the steps of:
applying the composition for liquid crystal alignment layer of claim 1 on a substrate; and
irradiating UV rays on the applied composition.

16. A liquid crystal alignment layer comprising the composition for liquid crystal alignment layer of claim 1.

17. The liquid crystal alignment layer according to claim 16, having a thickness of 30 to 1000 nm.

18. A liquid crystal cell comprising the liquid crystal alignment layer of claim 16.

19. The liquid crystal cell according to claim 18, wherein the liquid crystal cell is an IPS (In-Plane Switching) liquid crystal cell.

20. The liquid crystal cell according to claim 18, wherein the liquid crystal cell is a TN (Twisted-Nematic) liquid crystal cell.
